(19) United States
(12) Patent Application Publication
(10) Pub. No.: US 2011/0114125 A1
(43) Pub. Date: May 19, 2011

(54) METHOD FOR CLEANING A WAFER STAGE

(76) Inventors: Yong-Quan Chen, Taipei County (TW); Shu-Kuo Chiu, Taipei County (TW)

(21) Appl. No.: 12/764,975

(22) Filed: Apr. 22, 2010

(30) Foreign Application Priority Data
Nov. 13, 2009 (TW) 098138658

(51) Int. Cl. B08B 5/04

(52) U.S. Cl. 134/18

(57) ABSTRACT

A method for cleaning a wafer stage is provided. First, a wafer stage with a wafer thereon is provided. Second, a leveling scanning step is carried out to examine the evenness of the wafer. The wafer is removed from the wafer stage once an abnormal evenness is detected. Afterwards, a vacuum cleaner device is used to in-situ clean the surface of the wafer stage after the wafer is removed.

### BACKGROUND OF THE INVENTION

1. Field of the Invention

The present invention generally relates to a method for cleaning a wafer stage. In particular, the present invention is directed to a method for in-situ cleaning the surface of a wafer stage in an exposure apparatus by a vacuum cleaner device.

2. Description of the Prior Art

In the manufacturing process of semiconductor elements, a wafer usually undergoes various procedures, such as exposure, development, etching, ion implantation, washing . . . to be finished. During the lithographic step, a wafer is placed on a wafer stage to undergo a transfer of a pattern so the evenness of the wafer is one of the major reasons to influence the exposure results. In addition to the evenness of the exposure apparatus, the cleanness of the surface of the wafer stage is another potential reason to influence the exposure results.

Generally speaking, the wafer stage itself does not basically influence the exposure results. However, under certain circumstances, the wafer placed on the wafer stage is possible to slightly bulge owing to the contamination of foreign objects on the surface of the wafer stage, such as particles or dusts, so that the wafer is not totally even and flat. The uneven wafers suffer defocus in the exposure step, which causes the drop of the yield. Not only do the wafers need reworking, but also the wafer stages need re-cleaning. There are currently several conventional ways to clean the wafer stage.

The first one is to use a stickable wafer. Such kind of wafer is useful in sticking particles on the wafer stage so as to remove particles from the wafer stage. However, the problem is, because the inlet of the stickable wafer is different from that of the ordinary wafers, the stickable wafer can only be introduced after the entire batch is finished or the regular process would be interrupted. This is not an ideal solution for a real-time problem to remove contaminants from the surface of the wafer stage. Moreover, many wafers which need reworking accumulate after the entire batch is finished.

Another way is to use a cleaning stone (granite stone). The cleaning stone is used to clean the wafer stage by grinding the surface of the wafer stage for removing particles in order to get rid of the contaminants on the surface of the wafer stage. Still, the problem is that the cleaning stone can only be used after the entire batch is finished. This is still not an ideal solution for a real-time problem to remove contaminants from the surface of the wafer stage. Likewise, many wafers which need reworking accumulate after the entire batch is finished.

In view of the above-mentioned conventional ways, there is no real-time solution for removing contaminants from the surface of the wafer stage. Or in another aspect, more and more wafers which need reworking accumulate before the entire batch is finished. A novel solution is still needed to overcome the limitations of the current solutions.

### SUMMARY OF THE INVENTION

The present invention accordingly proposes a real-time solution for removing contaminants from the surface of the wafer stage without accumulating a lot of wafers which need reworking and queuing up for the end of a batch. The novel solution of the present invention overcomes the limitations of the current solutions.

The present invention in one aspect proposes a method for cleaning a wafer stage. First, a wafer stage with a wafer thereon is provided. Second, a leveling scanning step is carried out to examine the evenness of the wafer. Then, the wafer is removed from the wafer stage once an abnormal evenness is detected. Afterwards, a vacuum cleaner device is used to in-situ clean the surface of the wafer stage after the wafer is removed.

The present invention in another aspect proposes a method for cleaning a wafer stage. First, a wafer stage with a wafer thereon is provided. Second, a leveling scanning step is carried out to examine the evenness of the wafer. Later, the leveling scanning step generates a focus leveling analysis tool (FLAT). Then the focus leveling analysis tool is analyzed to predict the location of a particle on the surface of the wafer stage. Afterwards, the particle is removed provided a plurality of the focus leveling analysis tools of a plurality of the wafers predict the particle located between the wafer and the wafer stage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-8 illustrate examples of the method for cleaning a wafer stage of the present invention.

### DETAILED DESCRIPTION

The present invention provides a novel method for cleaning a wafer stage. In one aspect, the method of the present invention provides a real-time solution for removing contaminants from the surface of the wafer stage without stopping the whole manufacturing sequence. In another aspect, the method of the present invention may also reduce the number of the wafers which need reworking to as few as possible without leaving them queuing up for the end of a batch. The novel solution of the present invention increases the yield as well as reduces the manufacturing cost.

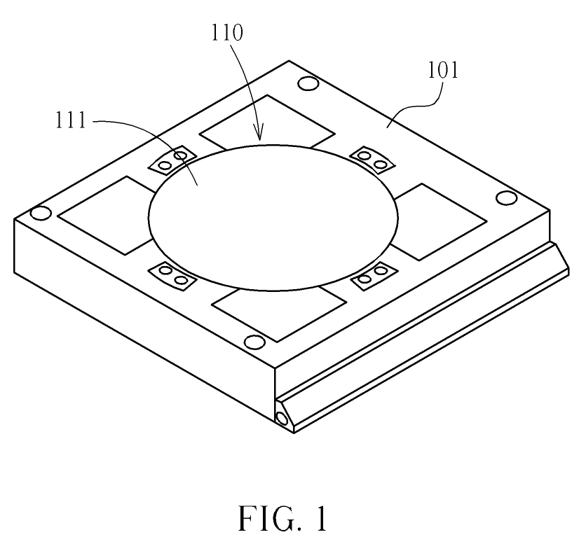

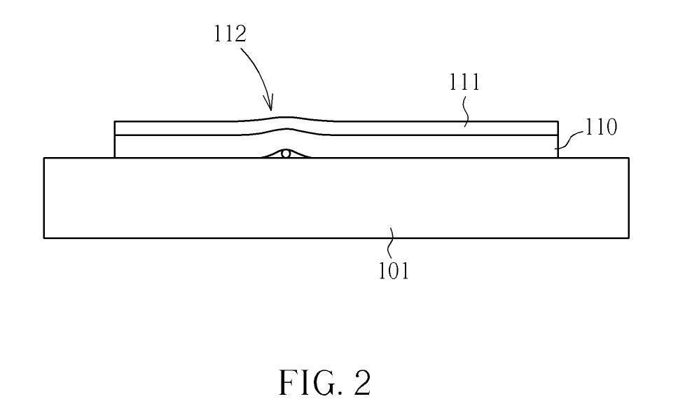

The present invention in one aspect provides a method for cleaning a wafer stage. FIGS. 1-8 illustrate an example of the method for cleaning a wafer stage of the present invention. First, as shown in FIG. 1, a wafer stage 101 is provided. The wafer stage 101 is usually a wafer stage in an exposure apparatus (not shown). There is a wafer 110 disposed on the wafer stage 101. For example, a photoresist layer 111 on the wafer 110 disposed on the wafer stage 101 is about to undergo a lithographic step, which transfers a pre-determined pattern (not shown) to the photoresist layer 111 disposed on the wafer 110. Second, as shown in FIG. 2, a leveling scanning step is usually carried out during the lithographic step to examine the evenness of the wafer 110. For example, an apparatus from ASML is able to examine the evenness of the wafer 110.

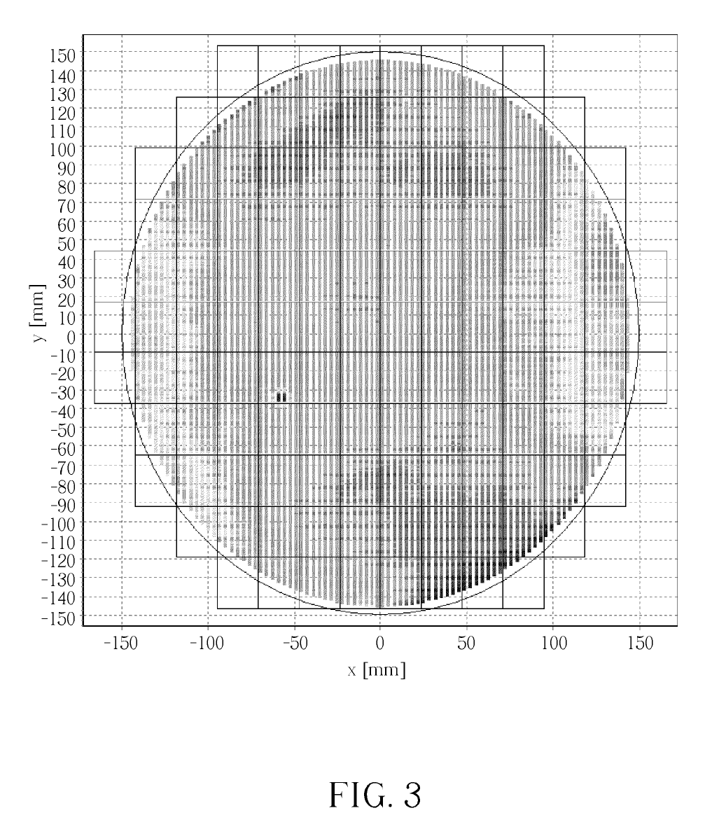

In one embodiment of the present invention, the leveling scanning step may generate a focus leveling analysis tool (FLAT) optically, as shown in FIG. 3. Then a computer program may be used to analyze the focus leveling analysis tool (FLAT). The results of the analysis are useful in predicting the reason or the cause of the abnormal evenness of the wafer 110. In addition, the results of the analysis are also useful in predicting whether the abnormal evenness of the wafer 110 results from some particles on the surface of the wafer stage 101. Because the abnormal evenness of the wafer 110 can be observed but the actual cause, such as some particles on the surface of the wafer stage 101, is very likely to be covered by the wafer 110, the results of the analysis are also useful in predicting the location of a specific particle on the surface of the wafer stage 101.

Sometimes, the actual cause of the abnormal evenness of the wafer 110 does not come from foreign objects, for example particles on the surface of the wafer stage 101. False alarm may likely be initiated once every time an abnormal evenness of the wafer 110 is always determined to be particles on the surface of the wafer stage 101. To screen out the false alarms as much as possible, in one embodiment of the present invention, the mechanism to remove particles is activated only when multiple focus leveling analysis tools of multiple wafers 110 predict the particle to be located between the wafer 110 and the wafer stage 101. Once there is actually a particle disposed on the surface of the wafer stage 101, multiple focus leveling analysis tools of multiple wafers 110 should predict similar information regarding the abnormal evenness of the wafers 110, which justifies the operational principle to reduce the false alarms. However, providing there is no particle on the surface of the wafer stage 101 or the actual cause is some reason else, the multiple focus leveling analysis tools of multiple wafers 110 should be mutually different.

Furthermore, the threshold to activate the mechanism to remove particles can be optionally set in accordance with the critical dimension (CD) of the process. Processes of different critical dimension (CD) naturally and intrinsically have different tolerance toward particles of different sizes. A suitable threshold of particle size range to activate the mechanism to remove particles not only is helpful in maintaining the efficiency of the lithographic step, but is also helpful in keeping a good lithography quality.

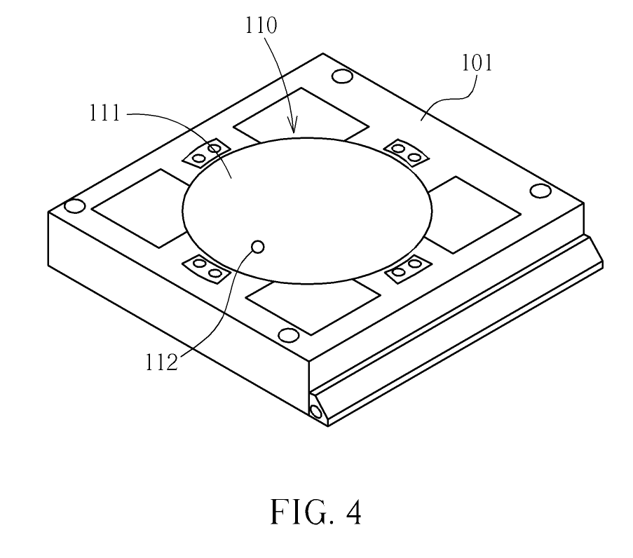

In one aspect, if the leveling scanning step does not pick up any signal regarding the abnormal evenness of the wafer 110, the lithography step is continued without delay. In another aspect, as shown in FIG. 2, if the leveling scanning step picks up a signal regarding the abnormal evenness 112, the lithography step still continues anyway. Next, as shown in FIG. 4, after the lithography step of this wafer is done, the wafer 110 is removed from the wafer stage 101 by a conventional way to reveal the cause of abnormal evenness 112.

After the lithography step is done and the wafer 110 is removed, the cause of the abnormal evenness 112 is finally revealed, usually a dust or a particle is exposed. The cause of the abnormal evenness 112 is usually dusts or particles sticking to the wafer 110 and coming along with the wafer 110 when the wafer 110 is loaded into the exposure apparatus (not shown). Once the wafer 110 is removed, the cause of the abnormal evenness 112, usually a dust or a particle, is revealed.

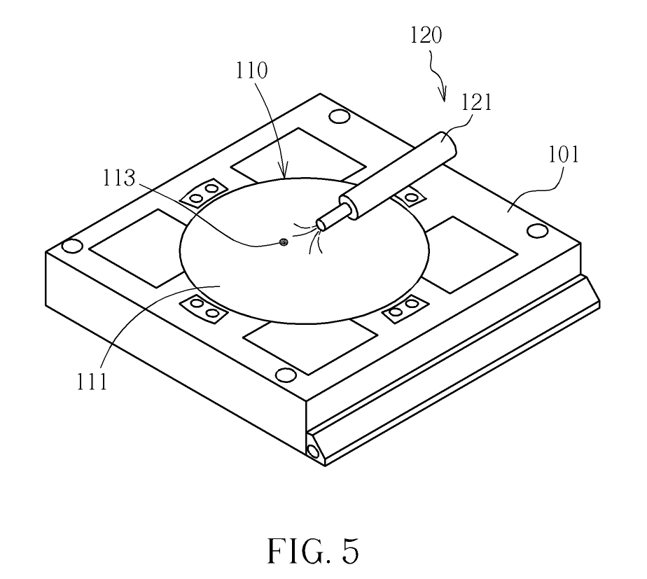

Then, as shown in FIG. 5, when the cause of the abnormal evenness 112, usually a dust or a particle, is exposed, a vacuum cleaner device 120 is used real-time to in-situ clean the surface of the wafer stage 101. The vacuum cleaner device 120 may have various ways to clean the surface of the wafer stage 101.

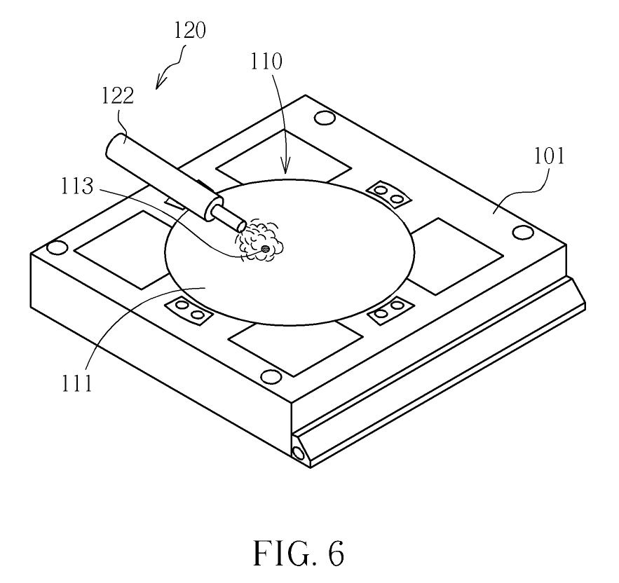

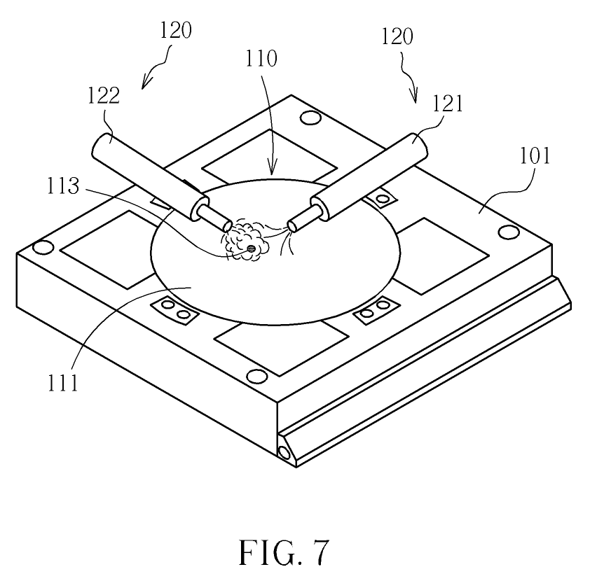

In one embodiment of the present invention, as shown in FIG. 5, the vacuum cleaner device 120 may include a vacuum suction nozzle to remove dusts or particles 113 by suction. For example, the vacuum suction nozzle may provide a suction with a vacuum difference of least 23 Kpa to remove dusts or particles 113. In another embodiment of the present invention, as shown in FIG. 6, the vacuum cleaner device 120 may include a gas purge nozzle 122 to remove dusts or particles 113 by gas purge, such as nitrogen gas. In still another embodiment of the present invention, as shown in FIG. 7, the vacuum cleaner device 120 may simultaneously include a vacuum suction nozzle 121 as well as a gas purge nozzle 122 so that the gas purge nozzle 122 purges nitrogen gas to help the vacuum suction nozzle 121 remove dusts or particles 113. In such a way, the combination may remove dusts or particles 113 much more easily which cannot be removed by a single vacuum suction nozzle 121 or a gas purge nozzle 122.

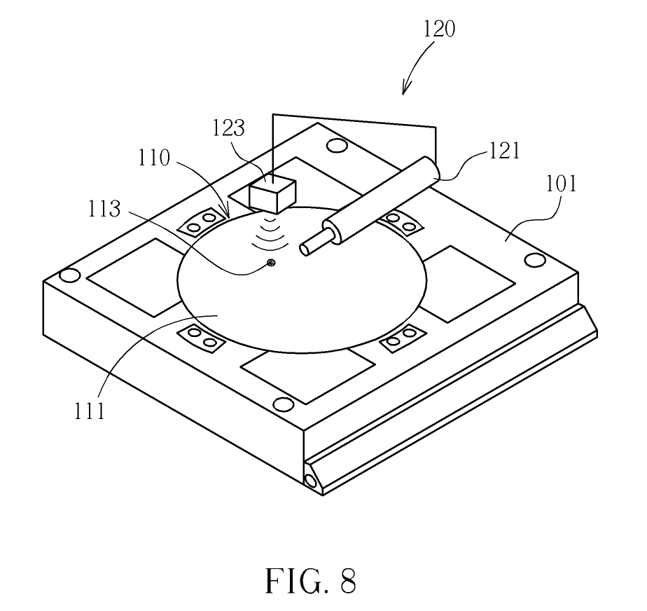

Preferably, as shown in FIG. 8, the vacuum cleaner device 120 may further include a positioning system 123. The positioning system 123 on one hand may detect the location of the exposed particle 113. The positioning system 123 on the other hand may guide and assist the vacuum cleaner device 120, such as the vacuum suction nozzle 121 and/or the gas purge nozzle 122 to remove the particles 113 much more precisely.

When the abnormal evenness 112 is compromised, the wafer stage 101 is back on to carry the wafer 110 again so that the following wafers 110 are free from the threat of the particles 113. In such a way, the wafer which needs reworking is down to only one and as a result the cost to rework is dramatically reduced. In another aspect, the method of the present invention can be activated promptly to compromise the situation once the abnormal evenness is detected. In such a way, not only is the response real-time, but also the situation can be compromised without stopping the process. Also, the method of the present invention does not spend a lot of time queuing up for the end of the batch so that the yield is higher and the cost becomes lower.

Those skilled in the art will readily observe that numerous modifications and alterations of the device and method may be made while retaining the teachings of the invention.

What is claimed is:

1. A method for cleaning a wafer stage, comprising:
providing a wafer stage with a wafer thereon;
performing a leveling scanning step to examine the evenness of said wafer;
removing said wafer from said wafer stage provided an abnormal evenness is detected; and
using a vacuum cleaner device to in-situ clean the surface of said wafer stage after said wafer is removed.

2. The method for cleaning a wafer stage of claim 1, wherein said wafer comprises a photoresist.

3. The method for cleaning a wafer stage of claim 1, wherein said leveling scanning step is carried out by a lithographic step.

4. The method for cleaning a wafer stage of claim 3, wherein a particle is removed in said lithographic step.

5. The method for cleaning a wafer stage of claim 3, wherein said wafer is removed after said lithographic step.

6. The method for cleaning a wafer stage of claim 4, wherein said wafer introduces said particle.

7. The method for cleaning a wafer stage of claim 1, wherein said leveling scanning step generates a focus leveling analysis tool (FLAT).

8. The method for cleaning a wafer stage of claim 7, wherein said focus leveling analysis tool is analyzed to predict the location of a particle on the surface of said wafer stage.

9. The method for cleaning a wafer stage of claim 1, wherein said vacuum cleaner device comprises a vacuum suction nozzle.

10. The method for cleaning a wafer stage of claim 1, wherein said vacuum cleaner device comprises a gas purge nozzle.

11. The method for cleaning a wafer stage of claim 10, wherein said gas purge nozzle purges nitrogen gas.

12. The method for cleaning a wafer stage of claim 11 wherein said gas purge nozzle purges nitrogen gas so that a vacuum suction nozzle is able to remove a particle.

13. The method for cleaning a wafer stage of claim 9, wherein said vacuum cleaner device comprises a positioning system to facilitate said vacuum suction nozzle to remove a particle.

14. The method for cleaning a wafer stage of claim 1, wherein said vacuum cleaner device generates a vacuum difference of at least 23 Kpa.

15. A method for cleaning a wafer stage, comprising:
providing a wafer stage with a wafer thereon;
performing a leveling scanning step to examine the evenness of said wafer;
generating a focus leveling analysis tool (FLAT) by said leveling scanning step;
analyzing said focus leveling analysis tool to predict the location of a particle on the surface of said wafer stage; and
removing said particle provided a plurality of said focus leveling analysis tools of a plurality of said wafers predict said particle located between said wafer and said wafer stage.

16. The method for cleaning a wafer stage of claim 15, wherein a vacuum cleaner device is used to in-situ remove said particle.

17. The method for cleaning a wafer stage of claim 15, wherein said vacuum cleaner device comprises a vacuum suction nozzle.

18. The method for cleaning a wafer stage of claim 17, wherein said vacuum cleaner device comprises a positioning system to facilitate said vacuum suction nozzle to remove said particle.

19. The method for cleaning a wafer stage of claim 16, wherein said vacuum cleaner device comprises a gas purge nozzle.

20. The method for cleaning a wafer stage of claim 19, wherein said gas purge nozzle purges nitrogen gas so that a vacuum suction nozzle is able to remove said particle.
